(19) United States
(12) Patent Application Publication
(10) Pub. No.: US 2014/0183032 A1
(43) Pub. Date: Jul. 3, 2014

(54) PROCESS FOR THE TREATMENT OF A RECYCLING STREAM FROM A PLANT FOR THE PRODUCTION OF POLYARYLENE ETHER

(71) Applicant: BASF SE, Ludwigshafen (DE)

(72) Inventors: Christoph Sigwart, Jeollanam-do (KR); Cornelis Hendricus De Ruiter, Mannheim (DE); Jutta Vonend, Bad Durkheim (DE); Jörg Erbes, Karlsruhe (DE)

(73) Assignee: BASF SE, Ludwigshafen (DE)

(21) Appl. No.: 14/140,947

(22) Filed: Dec. 26, 2013

Related U.S. Application Data
(60) Provisional application No. 61/746,580, filed on Dec. 28, 2012.

(51) Int. Cl. B01D 3/14

(52) U.S. Cl. CPC B01D 3/141
USPC 203/74; 203/91

(57) ABSTRACT

A process is proposed for the treatment of a recycling stream (1) from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent, comprising
from 60 to 90% by weight of water,
from 10 to 40% by weight of N-alkyl-2-pyrrolidone and, as contaminant detrimental to specification, up to 5000 ppm by weight of the alkylsuccinimide corresponding to the N-alkyl-2-pyrrolidone and, alongside this, up to 1000 ppm by weight of other substances with higher boiling point than N-alkyl-2-pyrrolidone, in particular inorganic salts, based in each case on the total weight of the recycling stream (1), where the entirety of the components gives 100% by weight,
   giving a pure N-alkyl-2-pyrrolidone stream (2) which can be returned to the plant for the production of polyarylene ether sulfones, via a final distillation, which comprises carrying out the final distillation process in a partitioned column (TK), with a partition (T) arranged in the longitudinal direction of the column and dividing the space within the partitioned column (TK) into an input region (A), an output region (B), an upper undivided region (C) of the column, and a lower undivided region (D) of the column, the recycling stream (1) being introduced into the column in the input section (A) of the same, and being separated, in the partitioned column (TK), into a bottom stream (7) comprising N-methylsuccinimide, an overhead stream (8) comprising water, and a pure NMP stream, as side stream (2) from the output section (B).

### CROSS-REFERENCE TO RELATED APPLICATIONS

This application claims the benefit of U.S. Provisional Application 61/746,580, filed Dec. 28, 2012, which is incorporated herein by reference.

The invention relates to a process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent.

Polyarylene ether sulfones are known with trademark Ultrason® from BASF SE and comprise in particular polyether sulfones (Ultrason® E), polysulfones (Ultrason® S) and polyphenyl sulfones (Ultrason® P).

Ultrason® E, Ultrason® S, and Ultrason® P are transparent plastics with high temperature resistance. They are used in many applications in engineering and in the electrical/electronics sector. There are also numerous reasons for a use as replacement for glass, metal, ceramic, and porcelain in the food-and-drinks sector and household sector: heat resistance extending to 180° C. or short periods at 220° C., good mechanical properties and high breakage resistance, resistance to superheated steam, and excellent resistance to chemicals.

Ultrason® E, S, and P are amorphous thermoplastic polymers with the following underlying structure:

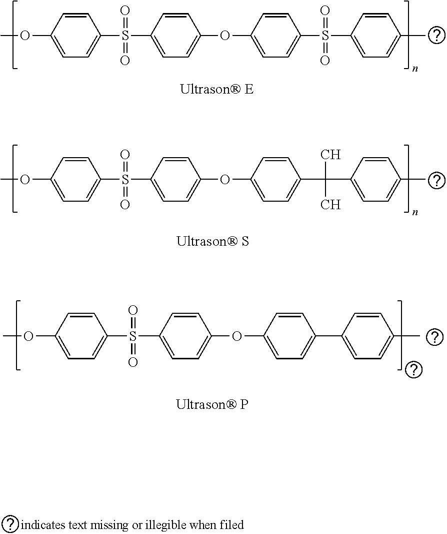

Moldings made of Ultrason® not only have high dimensional stability but also strength, stiffness, and toughness, these properties extending to the vicinity of the glass transition temperature.

The most important features of Ultrason® are:
properties independent of temperature
very high long-term service temperatures
good dimensional stability
high stiffness
high mechanical strength
good electrical insulation capability
advantageous dielectric properties
very advantageous fire performance
exceptional resistance to hydrolysis

The three Ultrason® parent polymers are amorphous thermoplastics and are transparent. However, by virtue of the high temperatures required during their production and processing they have a certain intrinsic color (pale golden yellow to ocher) which prevents achievement of the theoretically possible transmittance values for visible light. The qualities achievable currently are nevertheless suitable for very many transparent applications. Ultrason® also has high refractive indices in the visible wavelength region, and it therefore has another use in functional optical applications, for example lenses for electronic cameras.

Polyarylene ether sulfones are frequently produced via polycondensation in the presence of, as polar aprotic solvent, an N-alkyl-2-pyrrolidone, hereinafter abbreviated to NAP. N-methyl- or N-ethylpyrrolidone are particular N-alkyl-2-pyrrolidones used, and in particular N-methylpyrrolidone is used. Processes of this type are disclosed by way of example in U.S. Pat. No. 4,870,153, EP-A 113 112, EP-A 297 363, and EP-A 135 130.

Contaminated solvent arises in the above processes, and for economic and environmental reasons has to be treated and recycled into the process.

However, the solvent used in the above processes has to comply with the criteria for what is known as pure NAP, i.e. at least 99.0% by weight NAP content or else at least 99.5% by weight NAP content, or else at least 99.8% by weight NAP content, based in each case on the total weight of the pure NAP stream, and at most the following contents of components detrimental to specification: 0.1% by weight of water and 0.01% by weight of N-alkylsuccinimide, hereinafter abbreviated to NAS, based in each case on the total weight of the pure NAP stream.

Higher NAS contents in the NAP solvent have a disadvantageous effect on the color of the polyarylene ether sulfone, which is the useful product. This is surprising because not only NAP itself but also NAS, which can be produced by way of example via oxidation of NAP by atmospheric oxygen, are colorless substances. However, for the reasons described the market demands polyaryl ether sulfones with minimized intrinsic color.

Current thinking in relation to polyarylene ether sulfone production with NAP as solvent is that there is a causal connection between the NAS produced via oxidation of the NAP, for example the N-methylsuccinimide (NMS) produced via oxidation of N-methylpyrrolidone (NMP):

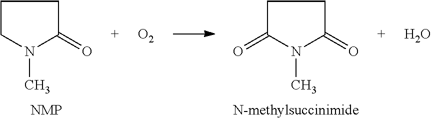

and the undesired intrinsic color of the final polyarylene ether sulfone product.

It is believed that NAS is a precursor for higher-molecular-weight colorant components which impair the intrinsic color of the final polyarylene ether sulfone product.

Before NAP-containing recycling streams are recycled into the production of polyarylene ether sulfone, they are therefore purified by final distillation in a traditional distillation column sufficiently to give a pure NAP complying with the criteria defined above.

CN 2007 100 39497 discloses a process for the reclamation of NMP as solvent from the polycondensation process to give para-phenylene terephthalamide, where the polymer is washed with deionized water, the wash solution is neutralized with a carbonate, oxide or hydroxide of an alkali metal or of an alkaline earth metal, and in two thin-layer evaporators, at a pressure of from 0.1 to 3.0 bar absolute and at a temperature of from 90 to 120° C. is subjected to initial distillation, and also then to final distillation, giving a pure NMP stream with purity higher than 99.5% and with water content below 100 ppm which is suitable for return into the polycondensation plant for the production of polymerizable para-phenylene terephthalamides.

When a conventional procedure, without preliminary evaporation, is used the heat exchanger for the bottom stream from the distillation column for pure NAP becomes blocked by contaminants after only a short time, and said plant therefore requires frequent shutdown for heat exchanger cleaning.

### BRIEF DESCRIPTION OF THE DRAWING

FIG. 1 shows a diagram of a preferred plant for carrying out the process of the invention.

### DETAILED DESCRIPTION OF THE INVENTION

In the light of this, it was an object of the invention to provide a process for the treatment of recycling streams from polyarylene ether sulfone processes via distillation to give pure NMP which can be recycled into the plant for carrying out a polyarylene ether sulfone process, where the process reliably provides an increased operation time of the distillation column and moreover minimizes required apparatus cost and energy cost, and where NMP losses are minimized. A particular intention is simultaneously to increase the purity of the NMP stream provided for recycling.

The object is achieved via a process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in N-alkyl-2-pyrrolidone as solvent, comprising
from 60 to 90% by weight of water,
from 10 to 40% by weight of N-alkyl-2-pyrrolidone and, as contaminant detrimental to specification, up to 5000 ppm by weight of the alkylsuccinimide corresponding to the N-alkyl-2-pyrrolidone and, alongside this, up to 1000 ppm by weight of other substances with higher boiling point than N-alkyl-2-pyrrolidone, in particular inorganic salts, based in each case on the total weight of the recycling stream, where the entirety of the components gives 100% by weight,
   giving a pure N-alkyl-2-pyrrolidone stream which can be returned to the plant for the production of polyarylene ether sulfones, via a final distillation process in a final column, which comprises carrying out the final distillation process in a partitioned column, with a partition arranged in the longitudinal direction of the column and dividing the space within the partitioned column into an input region, an output region, an upper undivided region of the column, and a lower undivided region of the column, the recycling stream being introduced into the column in the input section of the same, and being separated, in the partitioned column, into a bottom stream comprising N-methylsuccinimide, an overhead stream comprising water, and a pure NMP stream, as side stream from the output section.

It has been found to be possible to treat recycling streams from the production of polyarylene ether sulfones in a manner which is advantageous in terms of apparatus and of energy to give pure NMP, by carrying out the final distillation in a partitioned column, where preliminary purification via evaporation is carried out upstream of said column and, in one or more evaporator stages, reduces the content of salts of the recycling stream.

Partitioned columns for the distillative separation of mixtures into three or more fractions are known and are described by way of example in DE 3302525.

Partitioned columns are usually characterized by having what is known as a partition, i.e. a metal sheet arranged in the longitudinal direction of the column and dividing the space within the column. There are various embodiments of partitions. The partition usually extends only over a central region of the partitioned column, and divides said region into an input region and an output region. Adjacent to this central column region divided by the partition there is respectively a lower and an upper undivided column region, not divided by the partition.

Preference is given here to use of a partitioned column with a total of from 15 to 35, preferably from 20 to 30, theoretical plates.

The recycling stream preferably comprises from 60 to 90% by weight of water, from 10 to 40% by weight of N-alkyl-2-pyrrolidone and, as contaminant detrimental to specification, up to 1000 ppm by weight of the N-methylsuccinimide corresponding to the N-alkyl-2-pyrrolidone and, alongside this, up to 300 ppm by weight of other substances with higher boiling point than N-alkyl-2-pyrrolidone, in particular inorganic salts, based in each case on the total weight of the recycling stream, where the entirety of the components gives 100% by weight.

It is preferable that upstream of the partitioned column there is a distillation column into which the recycling stream is introduced, being separated in the upstream distillation column into a vapor stream which comprises water and is discharged, and a bottom stream which comprises at most 50% by weight of water, based on the total weight of the same, and which, optionally after further preliminary purification, is introduced into the partitioned column, in the input section of the same.

It is preferable that the N-alkylpyrrolidone is ethyl- or N-methylpyrrolidone, in particular N-methylpyrrolidone.

The distillation column that is preferably upstream of the partitioned column has in particular been designed with from 2 to 20, preferably from 5 to 15, theoretical plates.

The distillation column that is preferably upstream of the partitioned column is preferably operated with an overhead pressure in the range from 250 mbar absolute to atmospheric pressure, in such a way that most of the water comprised in the recycling stream is drawn off by way of the vapor stream from the upstream distillation column.

Before the bottom stream from the upstream distillation column is advantageously introduced as feed stream into the partitioned column it is advantageously subjected to preliminary purification in one or more evaporator stages.

The second evaporator stage is preferably operated at a pressure in the vapor space in the range from 250 to 500 mbar absolute, in such a way that most, in particular from 90 95%, of the N-methylpyrrolidone comprised in the recycling stream is drawn off by way of the vapor stream from the second evaporator stage, this stream being introduced as feed stream to the final column.

The second evaporator stage is advantageously operated at a pressure in the vapor space in the range from 300 to 400 mbar.

The third evaporator stage is preferably operated at a pressure in the vapor space in the range from 100 to 400 mbar.

The third evaporator stage is advantageously operated at a pressure in the vapor space in the range from 100 to 200 mbar.

It is particularly preferable to use a thin-layer evaporator as evaporator in the third evaporation stage. This is less susceptible to crusting by deposits, and a higher concentration level can therefore be reached, with correspondingly reduced N-alkyl-pyrrolidone losses.

The vapor steam from the second evaporator stage is advantageously introduced into the partitioned column above the vapor stream from the third evaporator stage.

The bottom stream from the partitioned column is preferably entirely discharged.

More preferably, only some of the bottom stream from the partitioned column is discharged, and the substream that is not discharged from the bottom stream here is returned to the final evaporator stage before the partitioned column.

The recycling stream is frequently composed of plurality of substreams arising in a plant for the production of polyarylene ether sulfones, in particular as described in WO 2007/147759, primarily during the use of water for polymer precipitation and, alongside this, also in salt separation and in exhaust gas scrubbing.

The final column is preferably operated at an overhead pressure at which it is still possible to use river water for cooling at the top of the column, in particular at an overhead pressure in the range from 100 to 300 mbar absolute.

The bottom temperature in the final column is adjusted to from 150 to 180° C., preferably to about 160 to 170° C., so that the bottom stream still comprises about 0.5 to 10% by weight of NAS, in particular still comprises about 1 to 5% by weight of NAS.

Pure NAS is drawn off as side stream from the final column, preferably from the stripping section thereof, in particular in the form of vapor.

The invention is explained in more detail below with reference to a drawing, and also to an inventive example:

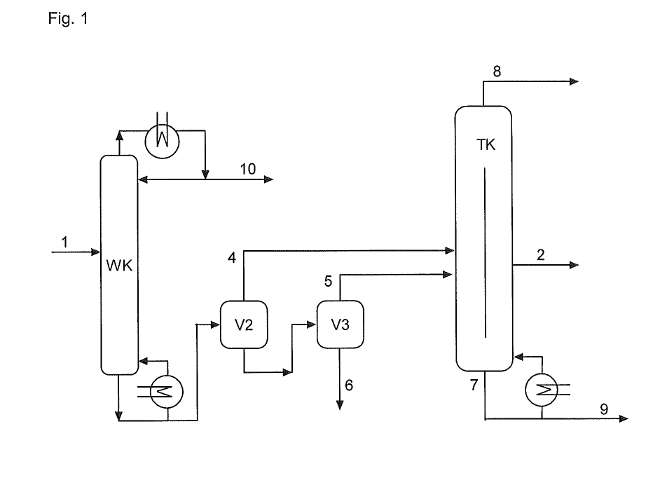

The single FIGURE, FIG. 1, is a diagram of a preferred plant for carrying out the process.

A NMP-containing recycling stream 1 is introduced into the first evaporator stage, which has been designed as column WK, and from which a vapor stream 10 predominantly comprising water is drawn off and discharged. The bottom stream from the column WK is introduced into the second evaporator stage V2; from this a further vapor stream 4 is drawn off and introduced as feed stream into the partitioned column TK.

The bottom stream from the second evaporator stage V2 is introduced into the third evaporator stage V3. From this, a further vapor stream 5 is drawn off and is introduced, as further feed stream, into the partitioned column TK.

A salt-containing bottom stream 6 is discharged from the third evaporator stage V3. The following are drawn off from the partitioned column TK: a pure NMP stream 2, as side stream, a bottom stream 7, which is discharged as stream 9, and also an overhead stream 8 which predominantly comprises water and which is sent for disposal.

### Inventive Example

The Aspen® simulation program from Aspen Technology Inc. was used to simulate a process for the treatment of a recycling stream 1 for a plant corresponding to the diagram in FIG. 1, whereupon the values listed in the table below were obtained for the composition of the streams.

The following operating conditions were assumed:

For the water column WK an overhead pressure of 1100 mbar absolute and a temperature of 102° C. at the top of the column, for the second evaporator stage V2 a pressure of 350 mbar absolute and a temperature of 150° C., for the third evaporator stage V3 a pressure of 150 mbar absolute and a temperature of 150° C., and for the partitioned column TK an overhead pressure of 197 mbar absolute and a temperature of 60° C. at the top of the column, or else a pressure of 214 mbar absolute and a bottom temperature of 151° C.

As can be seen from the table, NMP loss across the entire process is 0.76% (based on NMP introduced into the process by way of the recycling stream 1). NMS content in the pure NMP stream is 15 ppm by weight.

| | | | Pure NMP | | | | Bottom | | Stream 9 | | | |
|---|---|---|---|---|---|---|---|---|---|---|---|---|
| | | | stream 2 (side | | Overhead | | stream 6 | | discharged | | Overhead | |
| | | | outlet) from | | stream 8 from | | from third | | from bottom | | stream 10 | |
| | Recycling | | partitioned | | partitioned | | evaporator | | of partitioned | | from water | |
| | stream 1 | | column TK | | column TK | | stage V3 | | column TK | | column | |
| | kg/h | % | kg/h | % | kg/h | % | kg/h | % | kg/h | % | kg/h | % |
| H₂O | 719.5 | 71.9 | 0.0 | 0.0 | 31.2 | 100 | 0.0 | 0.0 | 0.0 | 0.0 | 688.3 | 100.0 |
| KCl | 0.6 | 0.1 | 0.0 | 0.0 | 0.0 | 0.0 | 0.6 | 28.2 | 0.0 | 0.0 | 0.0 | 0.0 |
| NMP | 279.8 | 28.0 | 277.7 | 100.0 | 0.001 | 0.003 | 1.5 | 70.4 | 0.6 | 90.0 | 0.021 | 0.003 |
| NMS | 0.100 | 0.01 | 0.004 | 0.0015 | 0.0 | 0.0 | 0.0 | 1.4 | 0.1 | 10.0 | 0.0 | 0.0 |
| Total | 1000 | 100.0 | 277.7 | 100.0 | 31.2 | 100.0 | 2.1 | 100.0 | 0.7 | 100 | 688.3 | 100.0 |

| | |
|---|---|
| NMP loss | 0.76% |

1.-7. (canceled)

8. A process for the treatment of a recycling stream from a plant for the production of polyarylene ether sulfones via polycondensation of aromatic bishalogen compounds and of aromatic bisphenols or their salts in the presence of at least one alkali metal carbonate or ammonium carbonate or alkali metal hydrogencarbonate or ammonium hydrogencarbonate in an N-alkyl-2-pyrrolidone as solvent, comprising
from 60 to 90% by weight of water,
from 10 to 40% by weight of the N-alkyl-2-pyrrolidone and, as contaminant detrimental to specification, up to 5000 ppm by weight of the alkylsuccinimide corresponding to the N-alkyl-2-pyrrolidone and, alongside this, up to 1000 ppm by weight of other substances with higher boiling point than N-alkyl-2-pyrrolidone, based in each case on the total weight of the recycling stream, where the entirety of the components does not exceed 100% by weight,
giving a pure N-alkyl-2-pyrrolidone stream which can be returned to the plant for the production of polyarylene ether sulfones, via a final distillation, which comprises carrying out the final distillation process in a partitioned column, with a partition arranged in the longitudinal direction of the column and dividing the space within the partitioned column into an input region, an output region, an upper undivided region of the column, and a lower undivided region of the column, the recycling stream being introduced into the column in the input section of the same, and being separated, in the partitioned column, into a bottom stream comprising N-methylsuccinimide, an overhead stream comprising water, and a pure NMP stream, as side stream from the output section.

9. The process according to claim 8, wherein the recycling stream comprises
from 60 to 90% by weight of water,
from 10 to 40% by weight of N-alkyl-2-pyrrolidone and, as contaminant detrimental to specification, up to 1000 ppm by weight of the N-methylsuccinimide corresponding to the N-alkyl-2-pyrrolidone and, alongside this, up to 300 ppm by weight of other substances with higher boiling point than N-alkyl-2-pyrrolidone, based in each case on the total weight of the recycling stream, where the entirety of the components does not exceed 100% by weight.

10. The process according to claim 8, wherein the N-alkyl-2-pyrrolidone is N-ethylpyrrolidone or N-methylpyrrolidone.

11. The process according to claim 8, wherein, upstream of the partitioned column there is a distillation column into which the recycling stream is introduced, being separated in the upstream distillation column into a vapor stream which comprises water and is discharged, and a bottom stream which comprises at most 50% by weight of water, based on the total weight of the same, and which, optionally after further preliminary purification, is introduced into the partitioned column, in the input section of the same.

12. The process according to claim 11, wherein, before the bottom stream from the upstream distillation column is introduced as feed stream into the partitioned column it is subjected to preliminary purification in one or more evaporator stages, where the bottom stream from the final stage of the one or more evaporator stages is discharged.

13. The process according to claim 8, wherein all or some of the bottom stream from the partitioned column is discharged as stream 9.

14. The process according to claim 13, wherein only some of the bottom stream from the partitioned column is discharged, and the substream that is not discharged from the bottom stream is returned to the final evaporator stage before the partitioned column.

15. The process according to claim 10, wherein the N-alkyl-2-pyrrolidone is N-methylpyrrolidone.
